(19) United States
(12) Patent Application Publication
(10) Pub. No.: US 2026/0189651 A1
(43) Pub. Date: Jul. 2, 2026

(54) PROCESSING DEVICE, PROCESSING SYSTEM, PROCESSING METHOD AND PROGRAM

(71) Applicant: Nippon Telegraph and Telephone Corporation, Tokyo (JP)

(72) Inventor: Shota ENDO, Musashino-shi, Tokyo (JP)

(21) Appl. No.: 18/867,899

(22) PCT Filed: Jun. 6, 2022
(86) PCT No.: PCT/JP2022/022833

§ 371 Date: Nov. 21, 2024

(51) Int. Cl. H04M 3/42

(52) U.S. Cl. CPC H04M 3/42; H04M 2203/6027

(57) ABSTRACT

A processing device 1 includes: a determination unit 31 that determines, when an outgoing call from an outgoing terminal 2 toward an incoming terminal 3 is detected, that the outgoing call is made by special fraud on the basis of an outgoing call number and an incoming call number of the outgoing call; and an instruction unit 32 that outputs an instruction to transfer the outgoing call to a phone number for handling special fraud.

### TECHNICAL FIELD

The present invention relates to a processing device, a processing system, a processing method, and a program.

### BACKGROUND ART

There is an increasing number of special fraud that uses a call to impersonate a close relative of a user, or a staff member of an arbitrary organization such as a city office staff, to defraud the user. There are devices that analyze voice data in a call to detect special fraud, and various analysis methods have been proposed.

For example, in Patent Literature 1, text data of voice data is compared with a learned model to calculate probability of being associated with a specific call, and in a case where the calculated probability is equal to or greater than a predetermined value, a predetermined terminal is notified of the result. Here, the learned model analyzes the call content between an outgoing terminal and an incoming terminal by using the text data created by a voice recognition device and the emotion analysis result analyzed by an emotion analysis device, and analyzes the possibility that the call is a specific call.

### CITATION LIST

### Patent Literature

Patent Literature 1: JP 2019-153961 A

### SUMMARY OF INVENTION

### Technical Problem

However, in the method described in Patent Literature 1, since the probability of being associated with a specific call is calculated using the learned model, a call with a pattern that cannot be handled by the learned model cannot be handled. In addition, in the method described in Patent Literature 1, it is only notified that the call is a specific call, and the user responds to the specific call. Therefore, the method is not considered sufficient as a countermeasure against special fraud.

The present invention is contrived in view of the above circumstances, and an object of the present invention is to provide a technology capable of appropriately preventing a user from being damaged in a case where a call is fraud.

### Solution to Problem

A processing device according to one aspect of the present invention includes: a determination unit that determines, when an outgoing call from an outgoing terminal toward an incoming terminal is detected, that the outgoing call is made by special fraud on the basis of an outgoing call number and an incoming call number of the outgoing call; and an instruction unit that outputs an instruction to transfer the outgoing call to a phone number for handling special fraud.

A processing system according to one aspect of the present invention includes: the processing device; an incoming SIP server that accommodates the incoming terminal; and a transfer SIP server that accommodates the phone number for handling special fraud. The incoming SIP server includes an incoming unit that notifies, when an outgoing call toward the incoming terminal is detected, the processing device of the detection, and a transfer unit that transfers, when an instruction transferred from the processing device is received, the outgoing call toward the incoming terminal to the phone number for handling special fraud. The transfer SIP server includes a response unit that emits a predetermined message and records a call with the outgoing terminal when an outgoing call from the outgoing terminal arrives at the phone number for handling special fraud.

A processing method according to one aspect of the present invention includes: causing a computer to determine, when an outgoing call from an outgoing terminal toward an incoming terminal is detected, that the outgoing call is made by special fraud on the basis of an outgoing call number and an incoming call number of the outgoing call; and causing the computer to output an instruction to transfer the outgoing call to a phone number for handling special fraud.

According to one aspect of the present invention, a program for causing a computer to function as the processing device is provided.

### Advantageous Effects of Invention

According to the present invention, it is possible to provide a technology capable of appropriately preventing a user from being damaged in a case where a call is fraud.

### BRIEF DESCRIPTION OF DRAWINGS

FIG. 1 is a diagram illustrating functional blocks of a processing system according to an embodiment of the present invention.

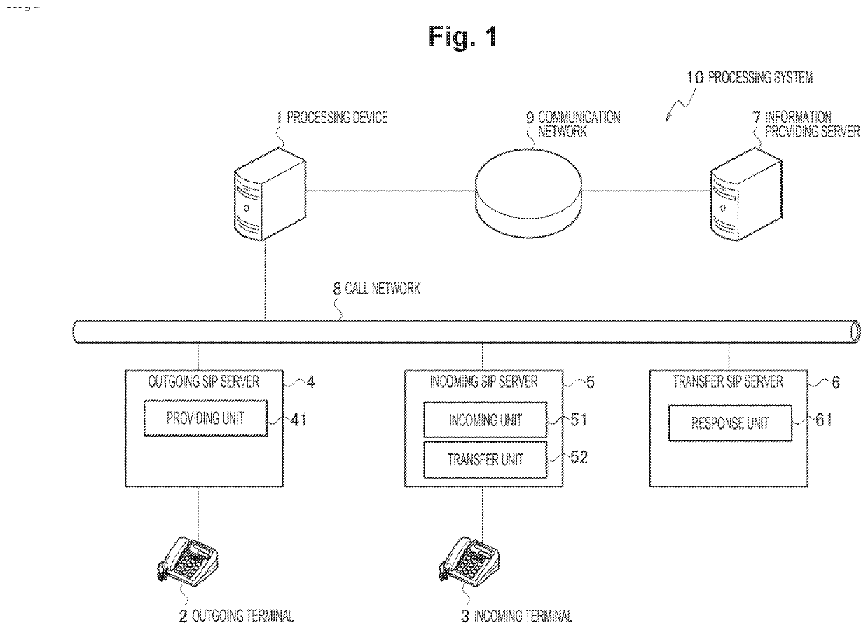

FIG. 2 is a sequence diagram illustrating a processing method in the processing system according to the embodiment of the present invention.

FIG. 3 is a block diagram illustrating functions of a processing device.

FIG. 4 is a flowchart illustrating processing of the processing device.

FIG. 5 is a diagram illustrating a hardware configuration of a computer used in the processing device.

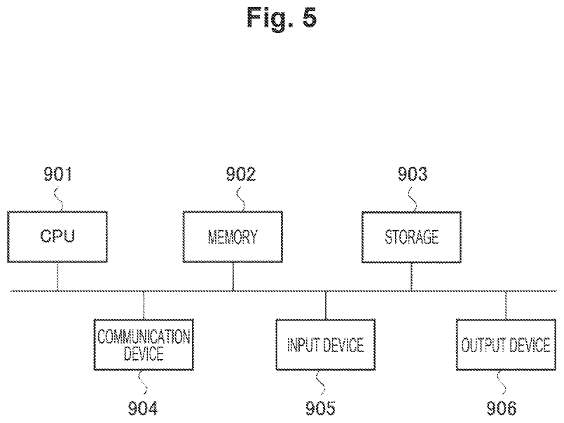

### DESCRIPTION OF EMBODIMENTS

Hereinafter, embodiments of the present invention will be described with reference to the drawings. In the drawings, the same reference signs are assigned to the same parts, and the description thereof is omitted.

### (Processing System)

In a case where an outgoing call from an outgoing terminal 2 toward an incoming terminal 3 is made by special fraud, a processing system 10 transfers the outgoing call to a phone number accommodated in a transfer session initiation protocol (SIP) server 6 and allows the outgoing call to arrive at the phone number. The transfer SIP server 6 reproduces a voice message for the call from the outgoing terminal 2. Therefore, since no call is established between the outgoing terminal 2 and the incoming terminal 3 and the receiver does not talk with the fraud suspect, damage caused by fraud is prevented.

The processing system 10 includes a processing device 1, an outgoing terminal 2, an incoming terminal 3, an outgoing SIP server 4, an incoming SIP server 5, a transfer SIP server 6, and an information providing server 7.

The processing device 1, the outgoing terminal 2, the incoming terminal 3, the outgoing SIP server 4, the incoming SIP server 5, and the transfer SIP server 6 are communicably connected to each other by a call network 8. The call network 8 is a network for realizing a call between the terminals accommodated in the respective SIP servers,

The processing device 1 and the information providing server 7 are communicably connected to each other by a communication network 9. The communication network 9 is a network for realizing transmission and reception of information such as the Internet.

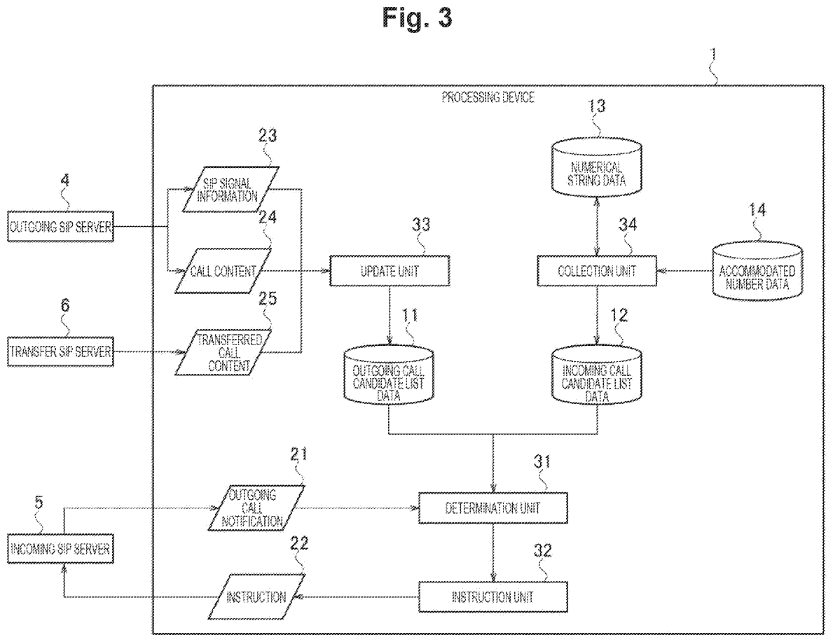

The processing device 1 determines whether an outgoing call from the outgoing terminal 2 toward the incoming terminal 3 is special fraud. In a case where the outgoing call is special fraud, the processing device 1 allows the outgoing call to arrive at the transfer SIP server 6, In a case where the outgoing call is not special fraud, the processing device 1 allows the outgoing call to arrive at the incoming terminal 3. The processing device 1 will be described in detail below with reference to FIG. 3.

The outgoing terminal 2 is a source terminal for the outgoing call that is a target for determination by the processing device 1 on whether it is special fraud. The incoming terminal 3 is a destination terminal for the outgoing call that is a target for determination by the processing device 1 on whether it is special fraud.

The outgoing SIP server 4 is an SIP server accommodating the outgoing terminal 2. The outgoing SIP server 4 transmits an SIP signal transmitted from the outgoing terminal 2 to the incoming SIP server 5.

The outgoing SIP server 4 includes a providing unit 41. The providing unit 41 provides data to be referred to in order to create outgoing call candidate list data 11, that may be an outgoing call number associated with special fraud, by the processing device 1. As shown in FIG. 3, the data to be provided to the processing device 1 by the providing unit 41 includes SIP signal information 23 that is related to the SIP signal of each terminal such as the outgoing terminal 2 accommodated in the outgoing SIP server 4, and call content 24 of each terminal.

The incoming SIP server 5 is an SIP server accommodating the incoming terminal 3. When an SIP signal of an outgoing call from the outgoing terminal 2 toward the incoming terminal 3 is received from the outgoing SIP server 4, the incoming SIP server 5 notifies the processing device 1 of the reception. The incoming SIP server 5 transfers the outgoing call from the outgoing terminal 2 to a phone number for handling special fraud or the transfer SIP server 6 in accordance with an instruction from the processing device 1.

The incoming SIP server 5 includes an incoming unit 51 and a transfer unit 52. When an outgoing call from the outgoing terminal 2 toward the incoming terminal 3 is detected, the incoming unit 51 notifies the processing device 1 of the detection, and notifies the incoming terminal 3 of the outgoing call when an instruction is issued from the processing device 1 to allow the outgoing call to arrive at the incoming terminal 3. When the instruction transferred from the processing device 1 with respect to the outgoing call from the outgoing terminal 2 toward the incoming terminal 3 is received, the transfer unit 52 transfers the outgoing call toward the incoming terminal 3 to a phone number for handling special fraud.

The transfer SIP server 6 accommodates a phone number for handling special fraud. When an outgoing call originating from the outgoing terminal 2 is transferred from the incoming SIP server 5, the transfer SIP server 6 allows the outgoing call to arrive at the phone number for special fraud countermeasures. The transfer SIP server 6 includes a response unit 61, When the outgoing call from the outgoing terminal 2 arrives at the phone number for handling special fraud, the response unit 61 emits a predetermined message and records the call with the outgoing terminal 2. Here, for example, the predetermined message informs that the call has arrived through automatic answering and provides information on the recording of the conversation. As shown in FIG. 3, the response unit 61 provides, to the processing device 1, transferred call content 25 that has been recorded.

The information providing server 7 is a server that provides phone numbers that may be targets of fraud. The information providing server 7 is, for example, a server that provides a bulletin board on which criminals exchange information, and a phone number that is likely to be a target of fraud by a criminal is posted on the bulletin board.

### (Processing Method)

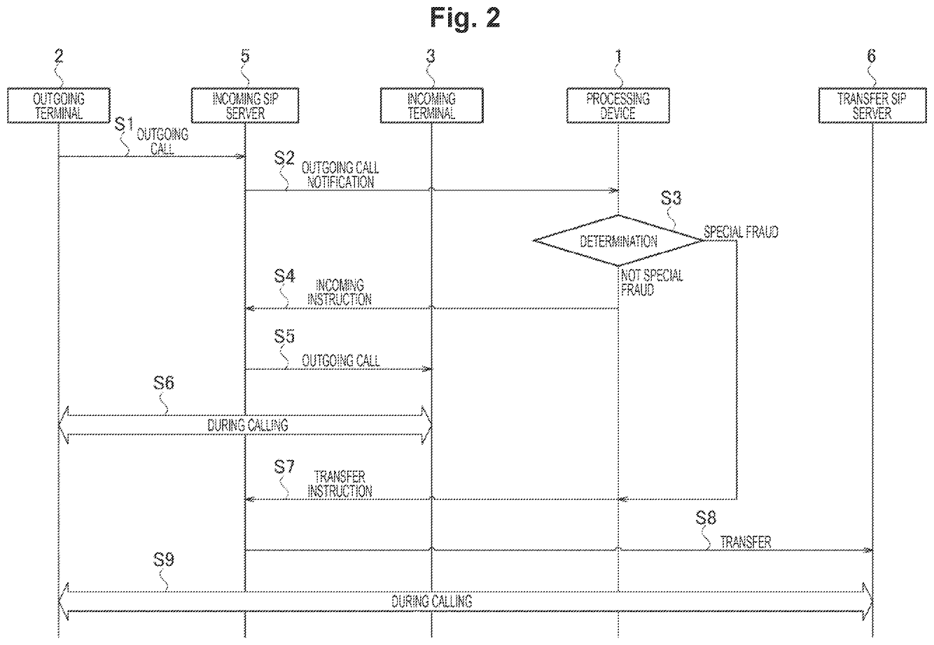

A processing method according to the embodiment of the present invention will be described with reference to FIG. 2. The content and order of the processing shown in FIG. 2 are merely an example, and the present invention is not limited thereto.

In Step S1, the outgoing terminal 2 transmits, to the incoming SIP server 5, an SIP signal to be sent toward the incoming terminal 3. In Step S2, the incoming SIP server 5 notifies the processing device 1 that there has been an outgoing call from the outgoing terminal 2. Here, the incoming SIP server 5 may notify the processing device 1 every time there is an incoming call toward each accommodated terminal, or may notify the processing device 1 when there is an incoming call toward a terminal satisfying a predetermined condition. For example, the incoming SIP server 5 holds incoming call candidate list data 12 in advance from the processing device 1, and notifies the processing device 1 in a case where there is an outgoing call toward a number registered in the incoming call candidate list data 12 or toward a number at which special fraud has occurred in the past.

In Step S3, when the outgoing call notification is received from the incoming SIP server 5, the processing device 1 determines whether the outgoing call is an outgoing call related to special fraud.

When the outgoing call is determined to be not special fraud, the processing device 1 transmits an incoming instruction to the incoming SIP server 5 in Step S4. When the incoming instruction is received, the incoming SIP server 5 notifies the incoming terminal 3 of the outgoing call from the outgoing terminal 2 in Step S5. When the incoming terminal 3 answers the call, the call is started between the outgoing terminal 2 and the incoming terminal 3 in Step S6.

When the outgoing call is determined to be special fraud, the processing device 1 transmits service order information serving as a transfer instruction to the incoming SIP server 5 in Step S7. The transfer instruction includes information specifying a transfer target and a phone number for handling special fraud as a transfer destination. The information specifying a transfer target includes, for example, the phone number of the outgoing terminal 2 and the phone number of the incoming terminal 3.

When the transfer instruction is received, in Step S8, the incoming SIP server 5 transmits the outgoing call from the outgoing terminal 2 toward the incoming terminal 3 to the transfer SIP server 6 accommodating the phone number for handling special fraud. When the transfer SIP server 6 allows the outgoing call from the outgoing terminal 2 to arrive at the phone number for handling special fraud, the call is started between the outgoing terminal 2 and the phone number for handling special fraud in Step S9. In this call, the transfer SIP server 6 emits an automatic answering message and records the call.

### (Processing Device)

As shown in FIG. 3, the processing device 1 includes data including outgoing call candidate list data 11, incoming call candidate list data 12, numerical string data 13, accommodated number data 14, an outgoing call notification 21, an instruction 22, SIP signal information 23, call content 24, and transferred call content 25, and functions of a determination unit 31, an instruction unit 32, an update unit 33, and a collection unit 34. The data is stored in a storage device such as a memory 902 or a storage 903. The functions are implemented by a CPU 901. The functions of the processing device 1 may be realized by a computer such as another SIP server.

The outgoing call candidate list data 11 includes phone numbers that may be outgoing call numbers of special fraud. The outgoing call number of special fraud is a phone number that is considered to be used by a criminal of the special fraud on the basis of the past call history and call content. The outgoing call candidate list data 11 is generated by the update unit 33.

The incoming call candidate list data 12 includes phone numbers that may be incoming call numbers of special fraud. The incoming call number of special fraud is a phone number listed as a target of fraud in the information providing server 7 or the like. The incoming call candidate list data 12 is generated by the collection unit 34.

The numerical string data 13 is data of numerical strings collected by the collection unit 34 from the information providing server 7 or the like. The numerical string data 13 includes a plurality of numerical strings that may be phone numbers such as 10-digit numerical strings starting with 03 and 11-digit numerical strings starting with 080 or 090.

The accommodated number data 14 is a list of phone numbers accommodated in the SIP server that is managed by the processing device 1. In the embodiment of the present invention, the processing device 1 manages the incoming SIP server 5. The accommodated number data 14 includes the phone numbers accommodated in the incoming SIP server 5.

The outgoing call notification 21 is a message from the incoming SIP server 5 to notify the processing device 1 that there has been an outgoing call toward the phone number accommodated in the incoming SIP server 5. The outgoing call notification 21 includes the phone number of the outgoing terminal 2 and the phone number of the incoming terminal 3.

The instruction 22 is a message from the processing device 1 to inform the incoming SIP server 5 of an instruction for the outgoing call notification 21. The instruction 22 is an incoming instruction or a transfer instruction,

The SIP signal information 23 is information related to the SIP signal of each terminal such as the outgoing terminal 2 accommodated in the outgoing SIP server 4. The SIP signal information 23 is provided from the outgoing SIP server 4. The SIP signal information 23 includes, for each phone number accommodated in the outgoing SIP server 4, various kinds of data such as a time zone in which an outgoing call is made, the number of outgoing calls, and the presence or absence of use of a robocall.

The call content 24 is call content of each terminal accommodated in the outgoing SIP server 4.

In the embodiment of the present invention, the SIP signal information 23 and the call content 24 are provided from the outgoing SIP server 4, but the present invention is not limited thereto. The processing device 1 may hold SIP signal information and call content for each phone number accommodated in each SIP server.

The transferred call content 25 is data of the content of the call with the outgoing terminal 2 at the phone number for handling special fraud. The transferred call content 25 is provided from the transfer SIP server 6.

When the outgoing call from the outgoing terminal 2 toward the incoming terminal 3 is detected, the determination unit 31 determines whether the outgoing call is made by special fraud on the basis of the outgoing call number and the incoming call number of the outgoing call. The determination unit 31 detects the outgoing call from the outgoing terminal 2 toward the incoming terminal 3 on the basis of the outgoing call notification 21 transmitted from the incoming SIP server 5.

With reference to the outgoing call candidate list data 11 and the incoming call candidate list data 12, the determination unit 31 determines that the outgoing call is made by special fraud in a case where the outgoing call number of the outgoing call is included in the outgoing call candidate list data 11 and the incoming call number of the outgoing call is included in the incoming call candidate list data 12. In contrast, in a case where the outgoing call number of the outgoing call is not included in the outgoing call candidate list data 11 or the incoming call number of the outgoing call is not included in the incoming call candidate list data 12, the determination unit 31 determines that the outgoing call is not made by special fraud.

In a case where the determination unit 31 determines that the outgoing call is made by special fraud, the instruction unit 32 outputs, to the incoming SIP server 5, an instruction 22 to transfer the outgoing call to the phone number for handling special fraud. In a case where the determination unit 31 determines that the outgoing call is not made by special fraud, the instruction unit 32 outputs, to the incoming SIP server 5, an instruction 22 to allow the outgoing call to arrive at the incoming call number.

The update unit 33 generates the outgoing call candidate list data 11 from the SIP signal information 23 and the call content 24 and updates, in a case where it is determined that a predetermined outgoing phone number is not related to special fraud, the outgoing call candidate list data 11 by deleting the phone number from the data.

With reference to the SIP signal information 23, the update unit 33 adds, in a case where various kinds of data such as a time zone in which an outgoing call is made from a predetermined phone number, the number of outgoing calls, and the presence or absence of use of a robocall are similar to a pattern of a criminal of special fraud, the phone number to the outgoing call candidate list data 11 as being associated with the criminal of the special fraud. The update unit 33 may determine whether the phone number is associated with a criminal of special fraud with a learned model that has learned patterns such as a time zone in which an outgoing call is made by a criminal of special fraud, the number of outgoing calls, and the presence or absence of use of a robocall,

In general, as a method for special fraud, an outgoing call may be made to a predetermined phone number by using a robocall in advance and a criminal may make an outgoing call to the number that has arrived at the robocall. Therefore, the use of a robocall is an index for determining whether the number may be an outgoing call number of special fraud.

In a case where it is determined from the transferred call content 25 that the transferred outgoing call is not made by a suspect of special fraud, the update unit 33 deletes the outgoing call number of the transferred outgoing call from the outgoing call candidate list data 11. For example, in a case where the call content in the transferred call content 25 does not include a keyword frequently appearing in special fraud, the update unit 33 determines that the outgoing call is not made by a suspect of the special fraud.

In addition, the update unit 33 may delete, from the outgoing call candidate list data 11, a phone number at which no outgoing calls have been made for a predetermined period. The update unit 33 may update the outgoing call candidate list data 11 on the basis of other determination criteria.

The collection unit 34 collects numerical strings having the same form as phone numbers from the information providing server 7, and collects, from among the collected numerical strings, phone numbers accommodated in the SIP server that is managed, as numbers that may be incoming call numbers of special fraud. The collection unit 34 searches the information providing server 7 by using, for example, a scraping technique, extracts numerical strings having a phone number form, and generates the numerical string data 13. The collection unit 34 matches the numerical string included in the numerical string data 13 with the phone number that is managed and included in the accommodated number data 14, and sets the numerical string included in both the numerical string data 13 and the accommodated number data 14 in the incoming call candidate list data 12. Therefore, the collection unit 34 can list the phone numbers listed as targets of fraud among criminals as phone numbers of potential fraud victims. The collection unit 34 may collect a phone number that is highly likely to be associated with a fraud victim by another method and set the phone number in the incoming call candidate list data 12.

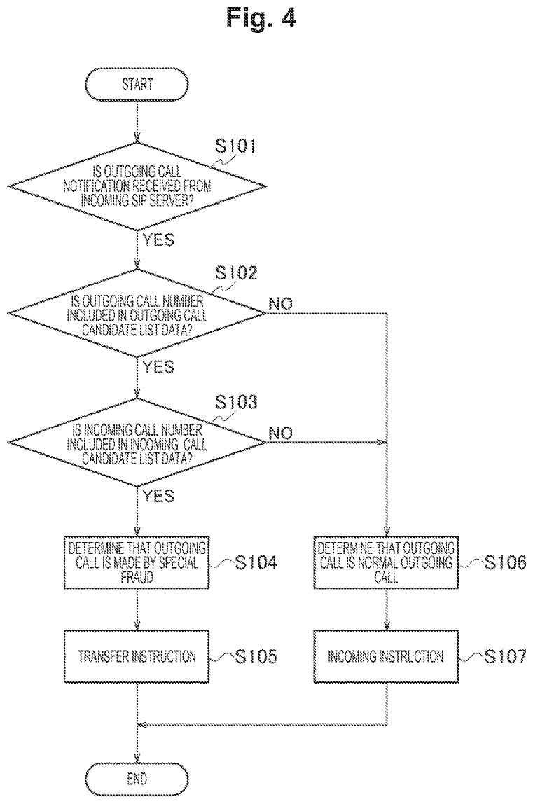

A processing method by the processing device 1 according to the embodiment of the present invention will be described with reference to FIG. 4. The content and order of the processing shown in FIG. 4 are merely an example, and the present invention is not limited thereto.

In Step S101, the processing device 1 waits for an outgoing call notification 21 from the incoming SIP server 5. When the outgoing call notification 21 is received from the incoming SIP server 5, the processing proceeds to Step S102.

In Step S102, the processing device 1 determines whether the outgoing call number included in the outgoing call notification 21 is included in the outgoing call candidate list data 11. In a case where the outgoing call number is not included, the processing proceeds to Step S106, and in a case where the outgoing call number is included, the processing proceeds to Step S103.

In Step S103, the processing device 1 determines whether the incoming call number included in the outgoing call notification 21 is included in the incoming call candidate list data 12. In a case where the incoming call number is not included, the processing proceeds to Step S106, and in a case where the incoming call number is included, the processing proceeds to Step S104.

In Step S104, since the outgoing call number included in the outgoing call notification 21 is included in the outgoing call candidate list data 11 and the incoming call number is included in the incoming call candidate list data 12, the processing device 1 determines that the outgoing call is made by special fraud. In Step S105, the processing device 1 instructs the incoming SIP server 5 to transfer the outgoing call to the phone number for handling special fraud.

Meanwhile, in Step S106, since the outgoing call number included in the outgoing call notification 21 is not included in the outgoing call candidate list data 11 or the incoming call number is not included in the incoming call candidate list data 12, the processing device 1 determines that the outgoing call is not made by special fraud but is a normal outgoing call. In Step S107, the processing device 1 instructs the incoming SIP server 5 to allow the outgoing call to arrive at the incoming terminal 3.

As described above, the processing system 10 according to the embodiment of the present invention transfers an outgoing call determined to be related to special fraud to the incoming SIP server 5, thereby not allowing the outgoing call related to the special fraud to arrive at the incoming terminal 3. As a result, it is possible to prevent damage caused by the special fraud related to the outgoing call.

In the processing system 10, by collecting the phone numbers leaked as targets of fraud damage or collecting the phone numbers of fraudulent criminals, it is possible to improve the accuracy of the call regarding special fraud.

Furthermore, the processing system 10 allows an outgoing call related to special fraud to arrive at the transfer SIP server 6 and records the utterance at the outgoing call number. Therefore, since the processing system 10 can determine whether the outgoing call number is a phone number of a fraudulent criminal on the basis of the recorded content, it is possible to improve the accuracy of the list of phone numbers of fraudulent criminals.

As the processing device 1 of the present embodiment described above, for example, a general-purpose computer system including the central processing unit (CPU, processor) 901, the memory 902, the storage 903 (hard disk drive (HDD), solid state drive (SSD)), a communication device 904, an input device 905, and an output device 906 is used. In the computer system, each function of the processing device 1 is realized by the CPU 901 executing a program loaded on the memory 902.

Note that the processing device 1 may be implemented by one computer, or may be implemented by a plurality of computers. In addition, the processing device 1 may be a virtual machine that is implemented in a computer.

The program of the processing device 1 can be stored in a computer-readable recording medium such as an HDD, an SSD, a universal serial bus (USB) memory, a compact disc (CD), or a digital versatile disc (DVD), or can be distributed via a network.

Note that the present invention is not limited to the above embodiment, and various modifications can be made within the scope of the gist of the present invention.

### REFERENCE SIGNS LIST

1 Processing device
2 Outgoing terminal
3 Incoming terminal
4 Outgoing SIP server
5 Incoming SIP server
6 Transfer SIP server
7 Information providing server
8 Call network
9 Communication network
10 Processing system
11 Outgoing call candidate list data
12 Incoming call candidate list data
13 Numerical string data
14 Accommodated number data
21 Outgoing call notification
22 Instruction
23 SIP signal information
24 Call content
25 Transferred call content
41 Providing unit
51 Incoming unit
52 Transfer unit
61 Response unit
901 CPU
902 Memory
903 Storage
904 Communication device
905 Input device
906 Output device

1. A processing device comprising:
a determination unit, including one or more processors, configured to determine, when an outgoing call from an outgoing terminal toward an incoming terminal is detected, that the outgoing call is made by special fraud on the basis of an outgoing call number and an incoming call number of the outgoing call; and
an instruction unit, including one or more processors, configured to output an instruction to transfer the outgoing call to a phone number for handling special fraud.

2. The processing device according to claim 1,
wherein, with reference to outgoing call candidate list data including a phone number that may be an outgoing call number of special fraud and incoming call candidate list data including a phone number that may be an incoming call number of special fraud, the determination unit is configured to determine that the outgoing call is made by special fraud in a case where the outgoing call number of the outgoing call is included in the outgoing call candidate list data and the incoming call number of the outgoing call is included in the incoming call candidate list data.

3. The processing device according to claim 2, further comprising:
a collection unit, including one or more processors, configured to collect numerical strings having the same form as phone numbers from an information providing server, and collect, from among the collected numerical strings, phone numbers accommodated in an SIP server that is managed, as numbers that may be incoming call numbers of special fraud.

4. The processing device according to claim 2, further comprising:
an update unit, including one or more processors, configured to delete, in a case where it is determined that the outgoing call is not made by a suspect of special fraud on the basis of call content with the outgoing terminal at the phone number for handling special fraud, the outgoing call number from the outgoing call candidate list data.

5. A processing system comprising:
the processing device according to claim 1;
an incoming SIP server that accommodates the incoming terminal; and
a transfer SIP server that accommodates the phone number for handling special fraud,
wherein the incoming SIP server includes
an incoming unit, including one or more processors, configured to notify, when an outgoing call toward the incoming terminal is detected, the processing device of the detection, and
a transfer unit, including one or more processors, configured to transfer, when an instruction transferred from the processing device is received, the outgoing call toward the incoming terminal to the phone number for handling special fraud, and
the transfer SIP server includes
a response unit, including one or more processors, configured to that emit a predetermined message and records a call with the outgoing terminal when an outgoing call from the outgoing terminal arrives at the phone number for handling special fraud.

6. A processing method comprising:
determining, when an outgoing call from an outgoing terminal toward an incoming terminal is detected, that the outgoing call is made by special fraud on the basis of an outgoing call number and an incoming call number of the outgoing call; and
outputting an instruction to transfer the outgoing call to a phone number for handling special fraud.

7. A non-transitory computer-readable storage medium storing a program for causing a computer to perform operations comprising:
determining, when an outgoing call from an outgoing terminal toward an incoming terminal is detected, that the outgoing call is made by special fraud on the basis of an outgoing call number and an incoming call number of the outgoing call; and
outputting an instruction to transfer the outgoing call to a phone number for handling special fraud.

8. The non-transitory computer-readable storage medium according to claim 7, wherein the operations further comprise:
wherein, with reference to outgoing call candidate list data including a phone number that may be an outgoing call number of special fraud and incoming call candidate list data including a phone number that may be an incoming call number of special fraud, determining that the outgoing call is made by special fraud in a case where the outgoing call number of the outgoing call is included in the outgoing call candidate list data and the incoming call number of the outgoing call is included in the incoming call candidate list data.

9. The non-transitory computer-readable storage medium according to claim 8, wherein the operations further comprise:
collecting numerical strings having the same form as phone numbers from an information providing server, and collects, from among the collected numerical strings, phone numbers accommodated in an SIP server that is managed, as numbers that may be incoming call numbers of special fraud.

10. The non-transitory computer-readable storage medium according to claim 8, wherein the operations further comprise:
deleting, in a case where it is determined that the outgoing call is not made by a suspect of special fraud on the basis of call content with the outgoing terminal at the phone number for handling special fraud, the outgoing call number from the outgoing call candidate list data.

11. The processing method according to claim 8, further comprising:
wherein, with reference to outgoing call candidate list data including a phone number that may be an outgoing call number of special fraud and incoming call candidate list data including a phone number that may be an incoming call number of special fraud, determining that the outgoing call is made by special fraud in a case where the outgoing call number of the outgoing call is included in the outgoing call candidate list data and the incoming call number of the outgoing call is included in the incoming call candidate list data.

12. The processing method according to claim 11, further comprising:
collecting numerical strings having the same form as phone numbers from an information providing server, and collects, from among the collected numerical strings, phone numbers accommodated in an SIP server that is managed, as numbers that may be incoming call numbers of special fraud.

13. The processing method according to claim 11, further comprising:
deleting, in a case where it is determined that the outgoing call is not made by a suspect of special fraud on the basis of call content with the outgoing terminal at the phone number for handling special fraud, the outgoing call number from the outgoing call candidate list data.
